(19) United States
(12) Patent Application Publication
(10) Pub. No.: US 2023/0020560 A1
(43) Pub. Date: Jan. 19, 2023

(54) T-LED AIR INCLUDED LIGHT TUBE

(71) Applicant: SIGNIFY HOLDING B.V., EINDHOVEN (NL)

(72) Inventors: PETER JOHANNES MARTINUS BUKKEMS, DEURNE (NL); JOHANNES PETRUS MARIA ANSEMS, HULSEL (NL); ALDEGONDA LUCIA WEIJERS, EINDHOVEN (NL)

(21) Appl. No.: 17/787,792

(22) PCT Filed: Dec. 21, 2020
(86) PCT No.: PCT/EP2020/087482

§ 371 Date: Jun. 21, 2022

(30) Foreign Application Priority Data
Jan. 2, 2020 (EP) 20150006.3

(51) Int. Cl. F21S 4/28; F21V 3/06; F21V 19/00

(52) U.S. Cl. CPC F21S 4/28; F21V 3/062; F21V 3/063; F21V 19/008; F21Y 2115/10

(57) ABSTRACT

The invention provides a light generating device (1000) comprising (i) a tubular enclosure (100) and (ii) a plurality of light sources (200) configured to generate light source light (201) configured within the tubular enclosure (100), wherein the light sources (200) comprise solid state light sources, wherein the enclosure (100) comprises an enclosure material (300) that is transmissive for at least part of the light source light (201), wherein the enclosure material (300) comprises polymeric foam material (310), wherein the polymeric foam material (310) has a volume fraction of gas voids (320) relative to the total volume of the polymeric foam material (310) including the gas voids (320) selected from the range of 10-95 vol. %, wherein the tubular enclosure (100) has a tube length (L1) of at least 400 mm and a wall thickness (w1) selected from the range of 0.5-6 mm.

### FIELD OF THE INVENTION

The invention relates to a light generating device. The invention also relates to a luminaire comprising such light generating device.

### BACKGROUND OF THE INVENTION

The use of LEDs in tubular housings is known in the art. US2010321921, for instance, describes a replacement light for a conventional fluorescent tube light for use in a conventional fluorescent fixture comprising: a tubular housing; a circuit board disposed within the housing; a pair of end caps disposed on opposing ends of the tubular housing with at least one pin connector extending from each end cap; an array of LEDs arranged longitudinally along the circuit board, a number and spacing of the LEDs being such as to uniformly and fully occupy a space between the end caps, wherein at least one of the connectors is electrically connected to the LEDs; and a wavelength-converting material in contact with at least a portion of the tubular housing, wherein the wavelength-converting material is excited by transmitted light from the LEDs to produce visible light.

### SUMMARY OF THE INVENTION

Tubular light sources hosting LEDs are known in the art. There appears to be a desire to replace tubular glass bulbs with polymer based tubes. They may be easier to produce and properties may be easier to control. Further, the resulting product may be lighter than glass-based tubes. It surprisingly appears, however, that polymer-based tubes have in some respect worse properties. For instance, it appeared that T5 tubes of PC cannot be made of sizes of 1200 mm or larger. T8 tubes of PC or PMMA may perhaps be made with a length up to about 1200 mm. However, lengths of 1500 mm appear not to be possible. Further, it has also been observed that the beam shape may not be controlled in an easy way.

Hence, it is an aspect of the invention to provide an alternative light generating device, which preferably further at least partly obviate(s) one or more of above-described drawbacks. The present invention may have as object to overcome or ameliorate at least one of the disadvantages of the prior art, or to provide a useful alternative.

In an aspect the invention provides a light generating device (“lighting device” or “device”) light generating device comprising (i) a tubular enclosure (“enclosure” or “tube”) and (ii) a plurality of light sources configured to generate light source light configured within the tubular enclosure. Especially, the light sources comprise solid state light sources. Further, the enclosure comprises an enclosure material, even more especially a polymeric enclosure material, that may be transmissive for at least part of the light source light. Especially, in embodiments the enclosure material comprises rigid polymeric foam material. In yet further specific embodiments, the polymeric foam material has a volume fraction of gas voids relative to the total volume of the polymeric foam material including the gas voids selected from the range of 10-98 vol. %, such as 10-95% in presently claimed embodiments. In specific embodiments, the tubular enclosure has a tube length (L1) of at least 400 mm, such as at least 500 mm. Further, in specific embodiments the tubular enclosure has a wall thickness (w1) selected from the range of 0.5-6 mm. Hence, especially the invention provides a light generating device comprising (i) a tubular enclosure and (ii) a plurality of light sources configured to generate light source light configured within the tubular enclosure, wherein the light sources comprise solid state light sources, wherein the enclosure comprises an enclosure material that is transmissive for at least part of the light source light, wherein the enclosure material comprises polymeric foam material, wherein the polymeric foam material has a volume fraction of gas voids relative to the total volume of the polymeric foam material including the gas voids selected from the range of 10-98 vol. %, such as 10-95%, wherein the tubular enclosure has a tube length (L1) of at least 400 mm, such as at least 500 mm, and a wall thickness (w1) selected from the range of 0.5-6 mm.

With such tubular devices, it appears possible to produce create relatively long light generating devices which may have a reduced bending and/or which may have an improved angular distribution of the light generated by the device. The presentation invention also allows a reduction of material use. Further, such device may be relatively light-weight. It appears also relatively easy to tune wall thickness and volume fraction of the gas voids, whereby the angular distribution of the light may be improved and/or light outcoupling may be tuned.

As indicated above, the light generating device comprising (i) a tubular enclosure. Especially, a cross-section (perpendicular to a length axis of the tubular enclosure) of the tubular enclosure may essentially be constant over the length of the tubular enclosure. Hence, over the length the shape of the internal cavity (defined by the tubular enclosure) and the outer shape of the tubular encloser may essentially be constant.

Further, the cross-sectional shape of the internal cavity and the cross-sectional outer shape may essentially be identical over the entire length of the tubular enclosure. This may thus imply that the wall thickness of the tubular enclosure along the length may essentially be constant. However, in embodiments the wall thickness of the tubular enclosure may also vary along the length. Especially, however the wall thickness of the tubular enclosure along the length may essentially be constant.

The wall thickness of the wall along the cross-section may in embodiments be constant. This would imply that a distance between an outer radius and an inner radius would be constant along 360°. However, in other embodiments the wall thickness may vary along the cross-section. Especially, in embodiments a first elongated part of the tubular enclosure defined by a first circular sector, and a second elongated part of the tubular enclosure defined by a second circular sector, wherein a wall thickness in the first circular section differs from a wall thickness in the second circular section. For instance, the first circular sector has a first central angle (θ1) selected from the range of 45-315°, wherein the second circular sector has second central angle (θ2) selected from the range of 45-315°, and wherein 240°≤θ1+θ2≤360°. For instance, an average wall thickness in the first circular section is at least 10%, like at least 20%, such as at least 30% larger than an average wall thickness in the second circular section. Alternatively, an average wall thickness in the second circular section is at least 10%, like at least 20%, such as at least 30% larger than an average wall thickness in the first circular section. In this way, transmission and reflection of light source light (see also below) may be controlled. In embodiments, there may be more than two of such elongated parts having different (average) wall thicknesses. As will be further discussed below, the wall thickness will in general be selected from the range of 0.5-6 mm. Typically the tubular enclosure has a wall which comprises or consists over its full length and full circumference, also referred to as cross-sectional shape, of foam material. Further, the cross-sectional shape comprises a fully closed circumference, i.e. it has a ring-shape, such as circular, oval, square, rectangular, or D-shape, which is continuous, i.e. not-interrupted by slits, cracks.

In embodiments, the cross-sectional shape of the internal cavity is essentially circular. In yet other embodiments, the cross-sectional shape of the internal cavity may be oval. In yet other embodiments, the cross-sectional shape of the internal cavity may also be free-shaped, such as having the shape of a peanut-like shape, or a D shape (or closed half circle shape). Further, in embodiments the cross-sectional shape of the outer shape is essentially circular. In yet other embodiments, the cross-sectional shape of the outer shape may be oval. In yet other embodiments, the cross-sectional shape of the outer cavity may also be free-shaped, such as having the shape of a peanut-like shape, or a D shape (or closed half circle shape). As indicated above, the cross-sectional shape of the internal cavity and the cross-sectional outer shape may essentially be identical over the entire length of the tubular enclosure, and may especially both essentially be circular.

The tubular enclosure may be provided with end elements for closing the tubular enclosure. One or both end elements may include one or more feed-throughs for electrical connectors or optional other elements, like e.g. fibers for communication. Hence, the end elements may include end closures. Further such end elements may include electrical connectors (which may in embodiments be integrated in the end closures).

Especially, the tubular enclosure has a tube length (L1) of at least 400 mm, such as at least 500 mm. In specific embodiments, the tubular enclosure may have a length (L1) between about 500-2500 mm. Especially, the length may be selected from the range of 600-2000 mm. Even more especially, the length may be selected from the group consisting of 600 mm, 900 mm, 1200 mm, 1500 mm, and 2000 mm.

The length of the tubular enclosures defined herein are used in relation to the installed length of the tubular enclosure and end elements, like end closures. In general, the real length of the tubular enclosures may even be up to about 10 cm shorter at each side, in general at maximum up to about 20 cm shorter in total. Hence, the lengths 600 mm, 900 mm, 1200 mm, 1500 mm, and 2000 mm, and similar lengths, may refer to tubular enclosures have a tubular length selected from the range of 400-600 mm, 700-900 mm, 1000-1200 mm, 1300-1500 mm, and 1800-2000 mm (and similar lengths indications that might be used for tubular lamps minus up to 10 cm at each side). For the larger tube diameters, the end elements may be a bit shorter, such as up to about 6 cm, or up to about 5 cm, at each side. For practical reasons, the common indications in relation to length are used. Hence, the tubular enclosure with voids as defined herein may have a tubular length e.g. selected from the range of 400-600 mm, 700-900 mm, 1000-1200 mm, 1300-1500 mm, and 1800-2000 mm. Hence, the phrase “tubular enclosure has a tube length (L1) of at least 500 mm”, and similar phrases, may refer to tubular enclosures having a length of at least 300 mm and including end elements of at least 500 mm.

As indicated above, the enclosure comprises an enclosure material that is transmissive for at least part of the light source light. Hence, thought the enclosure material may provide a closed tubular enclosure, light may be transmitted through the enclosure material, as it may be light transmissive; i.e. may have a relatively low absorption for the light source light. Hence, the tubular enclosure may also be indicated as a “light transmissive envelope”. This may be obtained by using a light transmissive material. The light transmissive material may comprise one or more materials selected from the group consisting of a transmissive organic material, such as selected from the group consisting of PE (polyethylene), PP (polypropylene), PEN (polyethylene napthalate), PC (polycarbonate), polyurethanes (PU), polymethylacrylate (PMA), polymethylmethacrylate (PMMA) (Plexiglas or Perspex), polymethacrylimide (PMI), polymethylmethacrylimide (PMMI), styrene acrylonitrile resin (SAN), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. one or more of polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN). Hence, the light transmissive material is especially a polymeric light transmissive material. Especially, the light transmissive material is selected from the group comprising PP, SAN, PMMA, PMMI, PC, PU, PET, and PEN. In yet other embodiments, a copolyester of one or more of the afore-mentioned (such as PP, SAN, PMMA, PMMI, PC, PU, PET, and PEN) may be applied.

Especially, the enclosure material comprises polymeric foam material. Hence, especially the enclosure material comprises a polymeric material that can be made into a foam, either via a physical foaming process or via chemical foaming process (or optionally both). See further also below. In such foam, voids are available, which may be filled with a gas, which may be produced during the chemical foaming process and/or which may be available during the (chemical of physical) foaming process as ambient gas. Hence, especially the voids may comprise air. With physical foaming, a very high void percentage may be obtained, in general even higher than with chemical foaming. In specific embodiments, the polymeric foam material has a volume fraction of gas voids relative to the total volume of the polymeric foam material including the gas voids selected from the range of 10-98 vol. %, such as selected from the range of about 10-95%, like e.g. at least about 15%. See further also below. The voids allow a lighter weight but also allow controlling the angular distribution of the light of the light generating device (“device light”).

Further, the light generating device a plurality of light sources configured to generate light source light. The light sources may be configured to generate the same type of light, like solid state light sources from the same bin (see also below). However, there may also be two or more subsets configured to generate light source light having different spectral power distributions (see also below). Especially, the plurality of light sources are configured within the tubular enclosure. The term plurality refers to at least 2. However, in general there may be much more light sources, such as at least 10. Especially, the light sources comprise solid state light sources.

As indicated above, the light sources are configured in the tubular enclosure. Hence, the tubular enclosure is configured downstream of the light sources. The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

Here below, some general aspects and embodiments in relation to light sources are provided.

The light generating device also comprise a light source. The light source is configured to generate light source light. In embodiments, the light source light comprises visible light. The term “light source” may also refer to “one or more light sources”, such as one or more the same or one or more different light sources.

As indicated above, the light generating device comprises one or more light sources, especially a plurality of light sources. The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode, such as a passive-matrix (PMOLED) or an active-matrix (AMOLED). In a specific embodiment, the light source comprises a solid state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of (essentially identical (or different)) light sources, such as 2-2000 solid state light sources. In embodiments, the light source may comprise one or more micro-optical elements (array of micro lenses) downstream of a single solid state light source, such as a LED, or downstream of a plurality of solid state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

Herein, the term “light source” especially refers to “solid state light source”. Especially, the light generating device comprises a plurality of solid state light sources.

The phrases “different light sources” or “a plurality of different light sources”, and similar phrases, may in embodiments refer to a plurality of solid state light sources selected from at least two different bins. Likewise, the phrases “identical light sources” or “a plurality of same light sources”, and similar phrases, may in embodiments refer to a plurality of solid state light sources selected from the same bin.

The terms “light source” or “solid state light source” may also refer to a package comprising a light source and optics, or especially a package comprising a solid state light source and optics, respectively. The optics may in specific embodiments comprise a lens, though alternatively or additionally, other optics may also be possible. In embodiments, the solid state light source(s) may be top emitters. Alternatively or additionally, in embodiments the solid state light source(s) may be side emitters.

The one or more light sources are configured to generate light source light. Especially, the light source light comprises visible light source light. In specific embodiments, the light source essentially consist of visible light source light. When there is more than one light source, one or more light sources may provide essentially the same radiation (i.e. radiation with same spectral power distribution). In yet other embodiments, when there are a plurality of light sources, there may be two or more light sources configured to generate light source light having different spectral power distributions. Further, when there are a plurality of light sources, at least one, especially at least 50%, may be configured to generate visible light. Optionally, one or more light sources may be configured to generate UV radiation or IR radiation.

Hence, in embodiments one or more of the light sources may be configured to generate UV light. Such UV light may have one or more wavelengths in the 100-380 nm wavelength region, such as in the 250-380 nm wavelength regions. IR radiation may have one or more wavelengths in the 800-10.000 nm wavelength region, such as one or more wavelengths in the IR-A (800-1400 nm) and/or in the IR-B (1400-3000 nm) and/or in the IR-C (3000-10000 nm). Especially, IR radiation may have one or more wavelengths in the 800-3000 nm wavelength region. IR radiation may e.g. be used for LiFi applications. The terms “Li-Fi” or LiFi (“light fidelity”) refers to a wireless communication technology, which utilizes light to transmit data and position between devices. Foams, like PU foams, may also be transmissive for UV and/or IR radiation. Would transmission be too low, a physical opening or channel may be created through which the UV and/or IR can propagate through the foam without having to be transmitted through the foam material (itself).

Especially, one or more, even more especially at least 50% of a plurality of the light sources, such as in embodiments essentially all, may be configured to generate visible light. The terms “visible”, “visible light” or “visible emission” and similar terms refer to light having one or more wavelengths in the range of about 380-780 nm.

As indicated above, wherein the enclosure comprises an enclosure material that is transmissive for at least part of the light source light. Hence, part of the light source light escapes from the enclosure and emanates away from the enclosure. Light emanating away from the light generating device is herein also indicated as “device light”. The device light comprises at least part of the light source light of the plurality of light sources that has escaped from the enclosure.

In specific embodiments, the light generating device is configured to generate white (especially in at least one operational mode or mode of operation). The term “white light” herein, is known to the person skilled in the art. It especially relates to light having a correlated color temperature (CCT) between about 1800 K and 20000 K, such as between 2000 and 20000 K, especially 2700-20000 K, for general lighting especially in the range of about 2700 K and 6500 K. In yet other embodiments, the CCT is selected from the range of 1800-6500 K. In embodiments, for backlighting purposes the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

When two or more light sources are configured to generate visible light, in specific embodiments the spectral distribution of the light generating device light may be controllable. Hence, two or more light sources are configured to generate visible light e.g. one or more of the color point and color rendering index may be controlled. Hence, in yet further specific embodiments the light generating device may be functionally coupled to or may comprise a control system.

For instance, in embodiments a first subset of light sources maybe configured to generate light source light with a first spectral power distribution and a second subset of the light sources may be configured to generate light source light with a second spectral power distribution different from the first. More subsets may also be available. In this way, e.g. light sources may be provided with two or more different correlated color temperatures. In this way, e.g. RGB light sources may be applied, or RGBY light sources may be applied, etc. When light sources have different spectral power distributions, the color points may e.g. differ with at least 0.005 for u′ and/or with least 0.005 for v′(CIE 1976 UCS (uniform chromaticity scale) diagram). For instance, in embodiments solid state light sources from different bins may be applied. The foam layer may also provide color mixing of the light source light of the different light sources. Hence, the foam layer may have a color mixing and/or homogenizing function(s).

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

The present invention allows freedom in amongst others the wall thickness of the tubular enclosure. By increasing the wall thickness, a higher stiffness may be obtained and void percentage and void size may even better be controlled to obtain a desirable distribution of the light emanating from the tubular enclosure. As indicated above, the wall thickness (w1) selected from the range of 0.5-6 mm. In specific embodiments, the wall thickness (w1) is at least 1 mm. Good (simulation) results were obtained with wall thickness of even larger than 1 mm. Hence, in embodiments the wall thickness (w1) may be larger than 1 mm, like at least 1.5 mm, such as 2 mm or larger. Especially, the wall thickness is equal to or smaller than 6 mm, such as equal to or smaller than 5 mm. With larger wall thickness, the desirable void volume fraction may have undesirable effect on the transmission (unless reflection is desired, see elsewhere). Hence, in embodiments the wall thickness is equal to or smaller than 6 mm.

Good results were obtained with enclosure lengths of at least 900 mm. It especially appears that the larger sized enclosures may not have the desired mechanical properties, wherein the presently proposed foam-based enclosure may have such properties, as well as the useful transmission and scattering. In specific embodiments, the tube length (L1) is at least 1200 mm. Even more especially, wherein the tube length (L1) is at least 1500 mm. It appears that larger sizes of polymeric enclosures, like 1200 mm or more, or even 1500 mm or more, are hardly possible, or even impossible, in view of mechanical properties. When increasing the wall thickness, bending behavior is unfavorable. However, with the present invention such length, also with wall thicknesses over 1 mm, appear to be possible with good mechanical properties.

Further, it appears that void volume fractions of at least 15%, such as even more at least about 20% may lead to desirable optical properties. Especially, the fraction of the gas void (or void volume fraction). Hence, in specific embodiments the tube length (L1) is at least 1200 mm, wherein the wall thickness (w1) is at least 1 mm, and wherein the volume fraction of gas voids relative to the total volume of the polymeric foam material including the gas voids is selected from the range of 30-95 vol. %.

It further appears that with increasing the external diameter, the number of light sources can be reduced while maintain homogeneity. Hence, less light sources may be used when the external diameter increases. This may save elements and in embodiment also energy. Here, it is especially referred to light sources as light emitting surfaces from which light with a specific spectral power distribution escapes. When different types of light sources are applied, the possible increase of pitch with increasing external diameter may refer to light sources of (essentially the same type). Hence, in specific embodiments the plurality of light sources comprises a subset of n1 light sources configured to generate light source light having the same spectral power distributions, wherein the tubular enclosure has an external diameter (D1), and wherein the n1 light sources of the subset of n1 light sources have a pitch (P), wherein D1≥1.5*P. The light generating device may comprise a plurality of different types of light sources. Hence, there may be more than one subset of light sources, wherein within the subsets the light source light generated by the respective light sources is essentially the same, whereas light source light generated by the respective light sources from different subsets may mutually differ. In such embodiments, the condition of D1≥1.5*P may apply to the light sources of a specific subset. Note that in specific embodiments the plurality of light sources of the light generating device may consist of a single subset. Further, the fact that there may be essentially identical light sources within a subset does not exclude that subsets within such subset are individually controlled.

Especially, homogeneity may be best when D1≥2.0*P. In specific embodiments, the tubular enclosure has an external diameter (D1), wherein the external diameter (D1) is selected from the range of at least 20 mm, such as especially at least 25 mm. In yet further embodiments, the tubular enclosure has an external diameter (D1), wherein the external diameter (D1) is selected from the range of at least 30 mm. With such diameter a high homogeneity of the device light with relatively low number of light sources may be provided. Also, with such diameter relatively long tubular enclosures may be provided, such as 1200 mm or larger, such as 1500 mm or larger. In embodiments, the external diameter (D1) is selected from the range of at maximum 60 mm, such as especially at maximum 50 mm.

Further, there also appeared a dependence on the wall thickness. Especially good result were obtained in embodiments wherein n1 is an integer value closest to a minimum LED count value N_{L,M}=(2.7*w1+30)/m, or larger than this integer value closest to the minimum LED count value N_{L,M}. Here, again it is especially referred to light sources as light emitting surfaces from which light with a specific spectral power distribution escapes. Assuming e.g. a wall thickness of 1.5 mm, then 2.7*1.5+30 is 34.05. Hence, n1 may be 34.05/m. This would imply that with length of 600 mm or 900 mm, n1 would be 20.43 LEDs or 30.6 LEDs, respectively, which would lead to 20 and 31 LEDs, respectively. When there is more than one subset of light sources, generating mutually different light source light (between the subsets; see also above), this condition may apply to the light sources in each subset. Hence, in embodiments the light generating device may comprise k subsets of each nₖ light sources, wherein the spectral power distributions of light source light of light sources of different subsets mutually differ, wherein for each respective nₖ applies that it is an integer value closest to a minimum LED count value N_{L,M}=(2.7*w1+30)/m, or larger than this integer value closest to the minimum LED count value N_{L,M}. More especially, integer value closest to a minimum LED count value N_{L,M} is ceiled value. Hence, in the above examples this would lead to 21 and 31 LEDs, respectively. Further, for even better results the offset may be a bit larger. Therefore, in specific embodiments n1 is an integer value closest to a minimum LED count value N_{L,M}=(2.7*w1+35)/m, or larger than this integer value closest to the minimum LED count value N_{L,M}, even more especially n1 is an integer value closest to a minimum LED count value N_{L,M}=(2.7*w1+39)/m, or larger than this integer value closest to the minimum LED count value N_{L,M}.

As indicated above, the tubular enclosure comprises polymeric material include voids. These voids may also be indicated as bubbles. Further, effectively such voids can be considered gas particles, having a particle size. Hence, especially the tubular enclosure comprises polymeric foam material. As can be derived from the above, the polymeric foam material may especially be selected from the group comprising PP, SAN, PMMA, PMMI, PC, PU, PET, PEN, (or a copolyester of one or more of the afore-mentioned).

Further, the particle size of the voids is especially in average 0.02 mm or larger, such as 0.1 mm or larger, like in embodiments 0.2 mm or larger. Smaller voids may provide too much scattering. Further, the particle size of the voids may especially in average be at maximum about 2.0 mm, such as at maximum about 1.8 mm. Larger size may lead to a too low scattering and thus the risk of glare. Hence, in specific embodiments the gas voids have a number average particle size of at least 0.02 mm, such as especially at least 0.2 mm and at maximum 1.8 mm. In embodiments, the particle size of the voids is especially in average 0.4 mm or larger. Yet in other embodiments, the particle size of the voids may especially in average be at maximum about 1.6 mm.

As indicated above, it may be useful to apply two (or more) different sections or parts. For instance, one part may be used to have light source light escape from the tubular enclosure and another part may be used to reflect light back. In this way, light will preferentially, or even essentially, escape from the one part and not via the other part. Such parts may be created by controlling one or more of the wall thickness, the volume fraction of the voids and the particle sizes of the voids

Hence, in specific embodiments a first elongated part of the tubular enclosure defined by a first circular sector has a first reflectivity R1, and a second elongated part of the tubular enclosure defined by a second circular sector has a second reflectivity R2, wherein R1>R2. Here, the term “reflectivity” refers to the reflectivity for one or more wavelengths of the light source light. Would the light source light have a dominant wavelength or a plurality of dominant wavelengths (from different spectra contributions, like e.g. a LED and a luminescent material), especially for the respective wavelengths the reflectivity may be defined by R1 and R2. In yet further specific embodiments, the first reflectivity R1 is selected from the range of at least 50% and the second reflectivity is selected from the range of 5-40%, such as especially 5-30%. In specific embodiments, the first reflectivity R1 is selected from the range of at least 80%, such as at least 90%. In further specific embodiments, the gas voids in the first elongated part have a number average particle size of at maximum 0.5 mm, and the gas voids in the second elongated part have a number average particle size of at least 0.6 mm and at maximum 1.8 mm. In this way, such reflectivity differences may be obtained.

The first and second parts may available over equal (radial) parts of the tubular enclosure, but may also have unequal (radial) parts. Further, there may also be more than two parts, such as. e.g. two parts as defined above, and between the two parts two parts with gradients. However, other embodiments may also be possible. In specific embodiments, the first circular sector has a first central angle (θ1) selected from the range of 45-315°, wherein the second circular sector has second central angle (θ2) selected from the range of 45-315°, and wherein 240°≤θ1+θ2≤360°. As indicated above, θ1+θ2 is not necessarily 360°; in specific embodiments, however, θ1+θ2=360°.

In view of the mechanical properties of the tubular enclosure, it may also be possible to include electronics in the enclosure. Hence, in embodiments the light generating device may further comprise an electronic component, wherein the electronic component is enclosed by the enclosure. The electronic component may e.g. comprise a ballast, a driver, a control system, a sensor, an antenna, etc. Especially, the electronic component comprises a driver and/or a ballast for the light sources. Especially, an electronic component may be comprised by at least one of the end closures. Hence, one or more electronic components may be comprised by one or more of the end closures.

In embodiments, at least part of the enclosure is obtainable by a chemical foaming process. In embodiments, at least part of the enclosure is obtainable by a physical foaming process. In embodiments, at least part of the enclosure is obtainable by a chemical foaming process and another part of the enclosure may be obtainable by a physical foaming process. Hence, in embodiments, at least part of the enclosure is obtainable by a chemical foaming process or a physical foaming process Here below, some further embodiments are described.

Especially, the foam enclosure comprises a foam material. Further, especially the foam material is transmissive for at least part of the light source light. Hence, the light generating device further comprises a foam material. Physical foams refer to foams that are generated under high pressures. Foams may also be made under ambient pressures (though elevated pressures are not necessarily excluded). Herein, the foams are especially obtainable (or especially obtained) via a low-pressure foaming process (see also below).

Foams may especially be produced while using foaming agents or blowing agents, which induce generation of gas. Due to the foaming agent, bubbles may be generated, whereby the foam is created.

The foam material is especially transmissive for at least part of the light source light. Hence, the foam material may essentially be colorless. In embodiments, the foam material may be transparent (for the light source light). In this way, light source light may enter the foam, propagate through the foam, but also exit again from the foam. The presence of bubbles leads to a scattering of the light source light. Hence, in this way the foam layer can be used as scattering element. Further, the foam layer can provide strength to the device and/or even have the function of a support, such as being self-supporting. Even more, in this way the foam allows generating light generating devices essentially without additional edge elements, as the foam may essentially provide the edge of the device. In embodiments, the foam enclosure may especially be scattering.

Further, the foam may protect the light sources. For that reason too, the foam layer is (mechanically) rigid. The rigidity of the foam material of the enclosure makes the use of further supporting element superfluous, rendering the light generating device of the invention to be relatively cheap and benefit from further reduction in weight. In specific embodiments, the foam layer may also be flexible, which may allow a flexible light generating device in embodiments. In presently claimed embodiments, the foam layer is (mechanically) rigid.

Suitable foam materials may be polyurethanes (PU). PU can be light transmissive, even light transparent. Other suitable foam materials may be selected from the group consisting of ethylene-vinyl acetate (EVA) foam, the copolymers of ethylene and vinyl acetate (also referred to as polyethylene-vinyl acetate (PEVA)), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS), polyethylene foam, polyvinyl chloride (PVC) foam, silicone foam, etc. . . . . Alternatively or additionally, a polycarbonate (PC) foam may be applied. Essentially any polymeric material may be used that is transmissive for visible radiation and that can be made as foam during polymerization.

The foam material is thus especially a polymeric material (like comprising organic polymers (such as mentioned above) and/or inorganic-organic polymers (like e.g. siloxane polymers). Hence, the term “foam material” may in specific embodiments also refer to a combination of different foam materials. The terms “foam layer” or “foam material” may also refer to multi-layer of identical or different types of foams.

In embodiments, the polymeric material may especially be based on the use of a chemical setting agent and/or on the basis of the use of a foaming agent, such as an aerosol, etc. Hence, in specific embodiments the term foam material, and similar terms, may herein also be indicated as “chemical foam material”.

In specific embodiments, the foam material comprises one or more of a polyurethane foam. PU foams can be relatively stable toward UV radiation and may have a relatively high transmission for visible light. Further, as indicated above, the foam material may also comprise a combination of different foam materials.

The transmission or light permeability can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

In specific embodiments, a material may be considered transmissive when the transmission of the radiation at a wavelength or in a wavelength range, especially at a wavelength or in a wavelength range of radiation generated by a source of radiation as herein described, through a 1 mm thick layer of the material, especially even through a 5 mm thick layer of the material, under perpendicular irradiation with said radiation is at least about 20%, such as at least 40%, like at least 60%, such as especially at least 80%, such as at least about 85%, such as even at least about 90%.

As indicated above, in embodiments the foam may at least partly enclose one or more of the one or more light sources. Hence, when there are a plurality of light sources, at least part of the plurality of light sources may be at least partly be enclosed by the foam. Such light sources may be in physical contact with the foam material. At least part of the external surface of such light source may be in contact with the foam material, such as at least about 20%, like in embodiments at least about 50%.

As indicated above, the foam comprises bubbles. The bubble size and the porosity may be controlled by controlled e.g. reaction time, concentration of foaming agents or blowing agents, the type of foaming agents or blowing agents, the type of polymeric material, as known in the art. The higher the porosity, the more scattering. The porosity may be defined as the volume of the bubbles relative to the total volume. Hence, porosity or void volume fraction is a measure of the void (i.e. “empty”) spaces in a material, and is a fraction of the volume of voids over the total volume, ranging in theory from larger than 0% to smaller than 100%.

Would bubbles not be spherical, then a spherical equivalent diameter may be applied as bubble size.

In specific embodiments, there may be a distribution of bubble sizes. It appears useful when there are relatively more smaller bubbles close to the external face, and relatively more larger bubbles closer to the light source. In this way, the spatial light distribution may be improved. Hence, in embodiments the number average bubble size decreases with increasing distance from the light source to the external face.

In yet a further aspect, the invention also provides a method of producing a light generating device. The method may comprise: providing (i) a mold and (ii) a light source configured to generate light source light. The method may further comprise: executing a foam formation stage to provide a foam enclosure, the foam formation stage comprising: providing a precursor material of a foam material in the mold and allowing the precursor material of the foam material to react to the foam material (during a foam formation time), wherein the foam material is transmissive for at least part of the light source light. Yet further, the method may comprise removing the thus formed foam enclosure from the mold. Further, the method may comprise one of arranging the light source in the thus formed foam enclosure. Therefore, the invention especially provides in embodiments a method of producing a light generating device comprising: (a) providing (i) a mold and (ii) a light source configured to generate light source light; (b) executing a foam formation stage to provide a foam enclosure, the foam formation stage comprising: providing a precursor material of a foam material in the mold and allowing the precursor material of the foam material to react to the foam material (during a foam formation time), wherein the foam material is transmissive for at least part of the light source light; and removing the thus formed foam enclosure from the mold; and (c) arranging the light source in the thus formed foam enclosure.

In embodiments, the mold is especially configured for shaping a tubular enclosure. In yet other embodiments, the mold is especially configured for shaping an elongated part of a tubular enclosure. By using the same mold or one or more other molds, one or more other elongated parts may be produced, which may be assembled into the tubular enclosure, such as by welding.

The method comprises executing a foam formation stage to provide a foam enclosure. The foam formation stage may comprise: providing a precursor material of a foam material in the mold and allowing the precursor material of the foam material to react to the foam material (during a foam formation time). As indicated above, the foam material is transmissive for at least part of the light source light. After at least part of the foam material is formed, the thus formed foam enclosure may be removing from the mold. This may not be done when the mold is designed as light transmissive window for the light generating device, such as the above indicated light transmissive envelope.

In specific embodiments, the method may comprise sequentially applying two or more different precursor materials. Such method may e.g. be used for obtaining a gradient in the bubble size. Alternative ways of bringing a gradient to the bubble size may be by e.g. 2K or 3K molding. Hence, in embodiments multi-layer molding may be applied. One of these molding steps can also be done with a non-foaming material.

Further, the foam material is provided by e.g. providing a layer comprising precursor of the foam material in the mold, and allowing the precursor of the foam material react to a foam material during a foam formation time.

The precursor material may in embodiments comprise monomers for forming the polymer. Further the precursor material may comprise a foaming agent. However, alternatively or additionally, other methods may be used to create to foam. For instance, in embodiments the polyurethane (precursor) may be blown onto the second support.

The precursor may (thus) in embodiments comprise the polymeric material (i.e. already (essentially) polymerized).

The phrase “allowing the precursor of the foam material react to a foam material during a foam formation time” may also indicate “allowing the precursor of the foam material develop to a foam material during a foam formation time”. Instead of the term “develop” in this phrase, also the term “rise” may be used.

In embodiments, monomeric ingredients are combined to form a hot liquid polyurethane, or other polymeric foamable material, and are passed down through a pipe into a nozzle head. Beneath the head may be a support, such as the mold or a part thereof. The nozzle jets a fine spray of hot liquid over the support, mixing with blasts of carbon dioxide (and/or other gas, such as N₂) coming from another nozzle. This causes the polyurethane (or other polymeric foamable material) to expand, forming a foam strip. The foam is comprised of a large number of tiny gas bubbles trapped in the polyurethane (or other polymeric foamable material).

In embodiments, a process similar to conventional injection molding may be applied with the exception that a foaming agent, typically nitrogen gas, may be mixed with the melted polymer and injected into a mold at low pressures. During injection the mold is not completely filled or packed out with resin as it would be with high pressure molding. Immediately following injection the gas/polymer mixture is allowed to expand to pack out the mold and to create a density reduced, rigid, plastic part.

In embodiments, aerosol based solutions may be chosen. For instance, insulating foam sealant products are available, which are sometimes called one-component foam. With the two component insulation products, the chemicals that make up the foam are kept separated in different drums or containers until mixed. The one-component foam (e.g. “foam in a can”) product may have already been partly mixed and partly reacted. That may be one of the reasons why this product is widely available. Hence, the foam material herein is especially obtainable via a low pressure foaming process. The term low pressure may refer to pressures at ambient pressure and especially lower than about 35 bar, such as in the range of 10-30 bar (1-3 MPa), or lower, such as in the range of about 1-10 bar.

Hence, in specific embodiments the foam material, and similar terms, may herein also be indicated as “low-pressure foam material”, respectively.

Low-pressure foaming technologies are known in the art.

Especially, a precursor material is selected that leads to a foam material which is transmissive for at least part of the light source light (see also above).

The reaction time may especially be chosen such that the desired foam material height (or thickness) is obtained. Note that in specific embodiments even after reaching a specific height, the polymerization reaction may continue.

As can be derived above, in specific embodiments the precursor of the foam material may be a precursor of a polyurethane foam or of a PC foam, or of a combination of a PC and a PU foam, especially (at least) a PU foam. However, as indicated above, other foams are not excluded.

A physical foaming process may in embodiments be obtained by direct gas injection into the melt with a physical foaming agent. This pressurized gas may be pressurized CO₂ and/or N₂. In specific embodiments, the pressurized gas may be provided as liquid (CO₂ and/or N₂), such as liquid N₂. The liquid gas returns to its gaseous state, thereby providing bubbles.

In yet a further aspect, the invention also provides a luminaire comprising the light generating device as described herein (such as in embodiments obtainable according to the method as described herein). In yet further embodiments, the invention also provides a luminaire comprising a plurality of the light generating devices as described herein.

The light generating device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some embodiments;

FIGS. 2a-2c schematically depict some further embodiments;

FIGS. 3a-3c show some simulations; and

FIG. 4 schematically depict an embodiment of the luminaire.

The schematic drawings are not necessarily to scale.

### DETAILED DESCRIPTION OF THE EMBODIMENTS

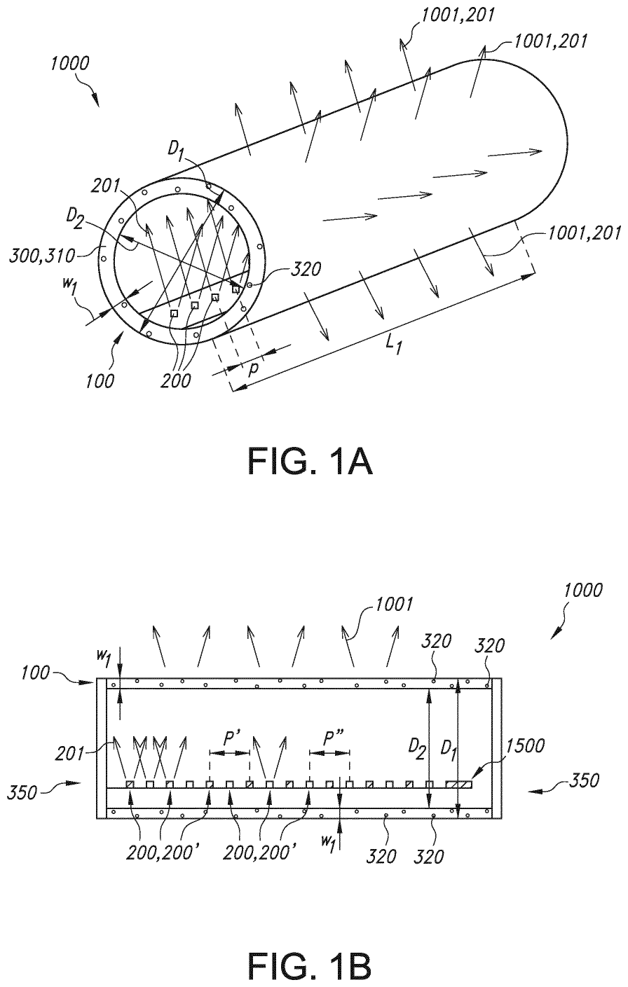

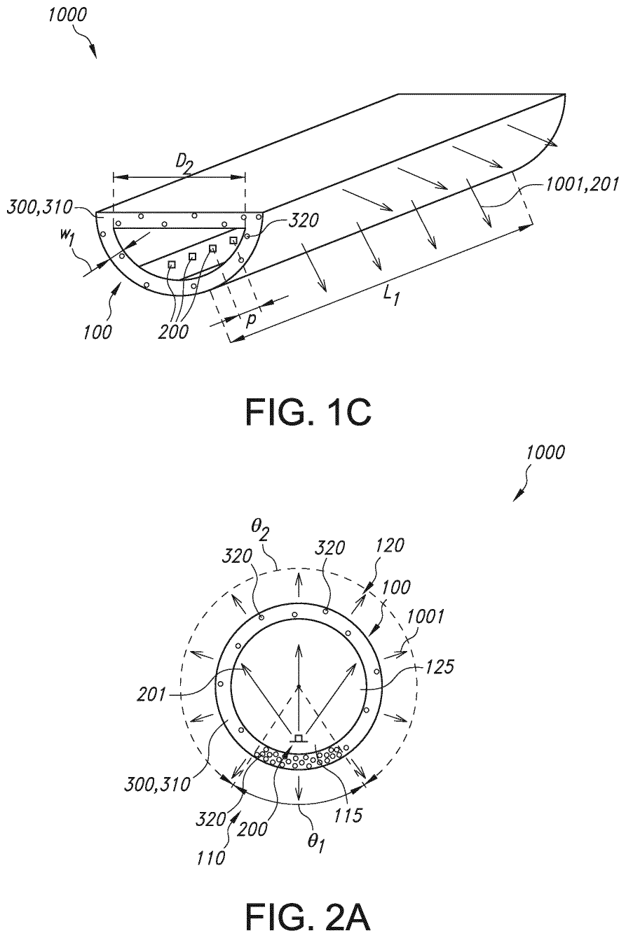

FIG. 1a schematically depicts a perspective view and FIG. 1b schematically depicts a cross-sectional view of an embodiment of the light generating device 1000. The light generating device 1000 comprising (i) a tubular enclosure 100 and (ii) a plurality of light sources 200 configured to generate light source light 201 configured within the tubular enclosure 100. The light sources 200 especially comprise solid state light sources, such as LEDs.

The enclosure 100 comprises an enclosure material 300 that is transmissive for at least part of the light source light 201. The enclosure material 300 comprises polymeric foam material 310. The polymeric foam material 310 has a volume fraction of gas voids 320 relative to the total volume of the polymeric foam material 310 selected from the range of 10-98 vol. %. In embodiments, the polymeric foam material 310 is selected from the group comprising PP, SAN, PMMA, PMMI, PC, PU, PET, PEN, or a copolyester of one or more of the afore-mentioned. At least part of the enclosure 100 is obtainable by a chemical foaming process or a physical foaming process.

The tubular enclosure 100 has a tube length L1 of at least 400 mm, such as at least 500 mm, and a wall thickness w1 selected from the range of 0.5-6 mm. In embodiments, tube length L1 is at least 1200 mm. In further specific embodiments, the tube length L1 is at least 1500 mm. In specific embodiments, the wall thickness w1 is at least 1 mm. In specific embodiments, the wall thickness w1 is larger than 1 mm. References D1 refers to an external diameter of the enclosure 100 and reference D2 refers to an internal diameter of the enclosure 100. The difference is the wall thickness w1. In specific embodiments, the tubular enclosure 100 has an external diameter D1, wherein the external diameter D1 is selected from the range of at least 30 mm.

The light sources 200 have a pitch P (see further also below).

Reference 350 (see FIG. 1b) indicates an end element, which may include an end closure and e.g. electronic connectors. Such end element 350 may be molded or glued to the enclosure 100. Not shown, but one or more electrical cables, or other electrical connectors, may enter the enclosure via such end element 350. In yet further specific embodiments, the volume fraction of gas voids 320 relative to the total volume of the polymeric foam material 310 is selected from the range of 30-95 vol. %. The gas voids 320 may in embodiments have a number average particle size of at least 0.2 mm and at maximum 1.8 mm.

FIG. 1b also very schematically depicts an embodiment wherein two types of light sources 200 are available, indicated with references 200′ and 200″. For instance, one type of light sources may emit white light and other type of light sources may emit white light with another correlated color temperature, or color light. Each type of light sources may have its own pitch. Hence, in embodiments the plurality of light sources 200 comprises a subset of n1 light sources 200 configured to generate light source light 201 having the same spectral power distributions, wherein the tubular enclosure 100 has an external diameter D1, and wherein the n1 light sources 200 of the subset of n1 light sources have a pitch P, wherein D1≥1.5*P.

The number of light sources may also depend to the thickness of the wall (at a fixed outer diameter). In specific embodiments, n1 is an integer value closest to a minimum LED count value N_{L,M}=2.7*w1+30/m, or larger than this integer value closest to the minimum LED count value N_{L,M}. This may lead to a homogeneous light distribution of the light source light escaping from the enclosure 100. As there may be more than one subset of light sources, each may have its own minimum light source count (such as LED count). For instance, in embodiments the light generating device 1000 may comprise k subsets of each nₖ light sources 200, wherein the spectral power distributions of light source light 201 of light sources 200 of different subsets mutually differ, wherein for each respective nₖ applies that it is an integer value closest to a minimum LED count value N_{L,M}=2.7*w1+30/m, or larger than this integer value closest to the minimum LED count value N_{L,M}.

The light generating device 1000 may further comprise an electronic component 1500. Here, the electronic component 1500 is enclosed by the enclosure 100. The electronic component may comprise a control system for controlling the light sources. Via (e.g. wireless) communication, the control system may be controlled via a user interface, though other options may also be possible, like one or more of sensor and timer that provide input to the control system.

FIG. 1c schematically depicts an embodiment of a D shape (or closed half circle shape) of the tubular enclosure 100.

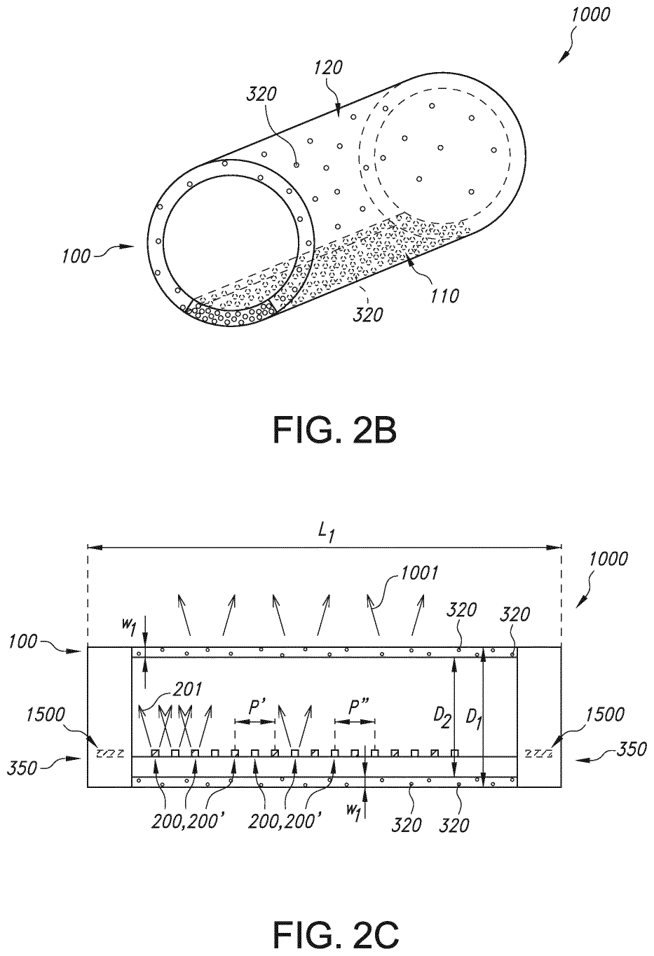

Referring to FIGS. 2a-2b, in embodiments the light generating device 1000 may comprise a first elongated part 110 of the tubular enclosure 100 defined by a first circular sector 115 having a first reflectivity R1, and a second elongated part 120 of the tubular enclosure 100 defined by a second circular sector 125, having a second reflectivity R2, wherein R1>R2. Especially, the first reflectivity R1 is selected from the range of at least 50% and the second reflectivity is selected from the range of 5-40%, such as e.g. 5-30%. Here, by way of example the void percentage is larger in the first part 110 than in the second part, but alternatively or additionally, the void size may differ and/or the number of voids may differ.

In specific embodiments, the gas voids 320 in the first elongated part 110 have a number average particle size of at maximum 0.5 mm, wherein the gas voids 320 in the second elongated part 120 have a number average particle size of at least 0.6 mm and at maximum 1.8 mm. The smaller void sizes (at about equal void volume fraction) may lead to a higher reflection.

As schematically depicted the first circular sector 115 has a first central angle θ1 selected from the range of 45-315°, wherein the second circular sector 125 has second central angle θ2 selected from the range of 45-315°, and wherein 240°≤θ1+θ2≤360°.

FIG. 2c schematically depicts an embodiment wherein the end elements 350. Reference L1 indicates the total length. Part of it may be the polymeric enclosure 100 with voids. The length thereof is indicated with L1′. In embodiments, L1−200 mm≤L1′≤L1. By way of example, electronics 1500 are enclosed by an end element 350 (see on the left and on the right the dashed elements 1500).

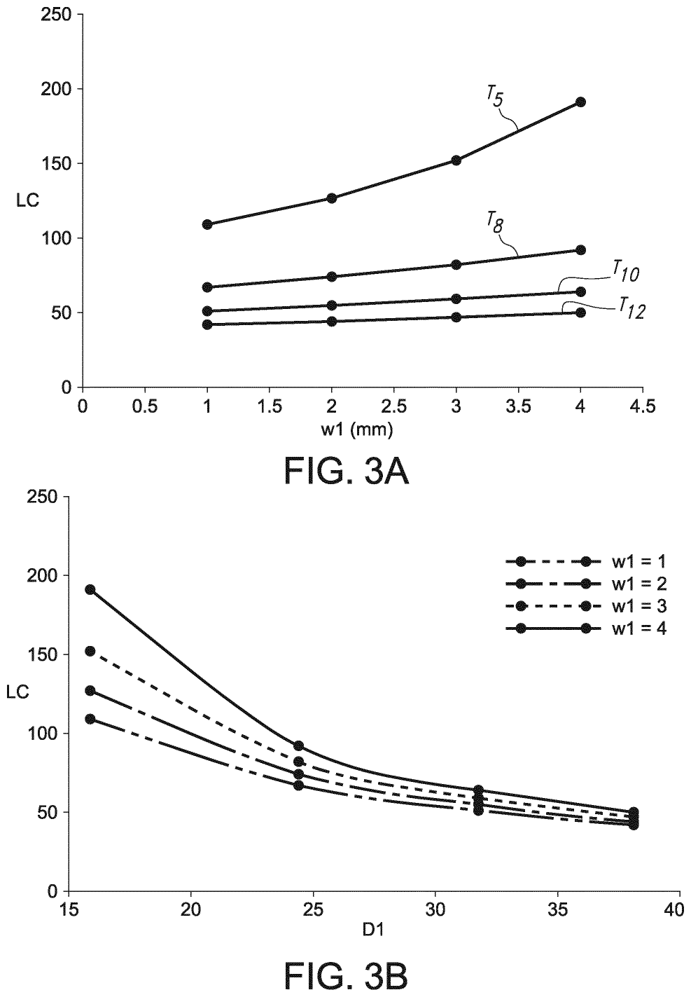

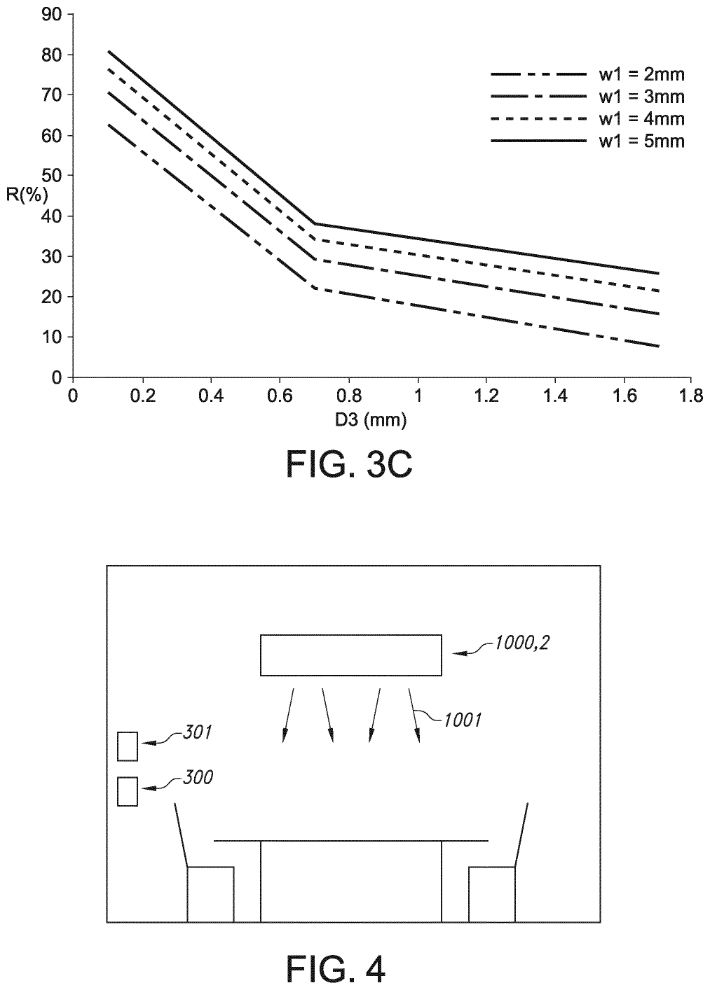

FIG. 3a shows the LED count LC, i.e. the number of LEDs per meter as function of the wall thickness w1 for T5, T8, T10, and T12 type enclosures. Note that LED count effectively may refer to count of light emitting surfaces of light sources such as LEDs. A cluster of light emitting surfaces with mutual distances smaller than about 1 mm, such as distances smaller than about 500 μm may still be considered a single light emitting surface.

FIG. 3b shows the LED count LC as function of the external diameter D1 of enclosures. See above the comments in relation to LED count and light emitting surfaces.

FIG. 3c shows the reflection R (%) as function of the average bubble size D3 (mm) for different wall thicknesses w1, i.e. 2, 3, 4 and 5 mm wall thickness.

FIG. 4 schematically depicts an embodiment of a luminaire 2 comprising the light generating device 1000 as described above. Reference 301 indicates a user interface which may be functionally coupled with the control system 300 comprised by or functionally coupled to the lighting generating device 1000.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating device comprising (i) a tubular enclosure and (ii) a plurality of light sources configured to generate light source light configured within the tubular enclosure, wherein the light sources comprise solid state light sources, wherein the enclosure comprises an enclosure material that is transmissive for at least part of the light source light, wherein the enclosure material comprises rigid polymeric foam material, wherein the polymeric foam material has a volume fraction of gas voids relative to the total volume of the polymeric foam material including the gas voids selected from the range of 10-95 vol. %, wherein the tubular enclosure has a tube length (L1) of at least 400 mm and a wall thickness (w1) selected from the range of 0.5-6 mm.

2. The light generating device according to claim 1, wherein the tube length (L1) is at least 1200 mm, wherein the wall thickness (w1) is at least 1 mm, and wherein the volume fraction of gas voids relative to the total volume of the polymeric foam material including the gas voids is selected from the range of 30-95 vol. %.

3. The light generating device according to claim 1, wherein the tubular enclosure comprises a gradient in size of the voids and/or a variation in wall thickness.

4. The light generating device according to claim 1, wherein the plurality of light sources comprises a subset of n1 light sources configured to generate light source light having the same spectral power distributions, wherein the tubular enclosure has an external diameter (D1), and wherein the n1 light sources of the subset of n1 light sources have a pitch (P), wherein D1≥1.5*P.

5. The light generating device according to claim 4, wherein n1 is an integer value closest to a minimum LED count value N_{L,M}=(2.7*w1+30)/m, or larger than this integer value closest to the minimum LED count value N_{L,M}.

6. The light generating device according to claim 1, wherein the wall thickness (w1) is larger than 1 mm and equal to or smaller than 6 mm.

7. The light generating device according to claim 1, wherein the tubular enclosure has an external diameter (D1), wherein the external diameter (D1) is selected from the range of at least 30 mm and at maximum 50 mm.

8. The light generating device according to claim 1, wherein the gas voids have a number average particle size of at least 0.02 mm and at maximum 1.8 mm.

9. The light generating device according to claim 1, wherein a first elongated part of the tubular enclosure defined by a first circular sector has a first reflectivity R1, wherein a second elongated part of the tubular enclosure defined by a second circular sector has a second reflectivity R2, wherein R1>R2.

10. The light generating device according to claim 9, wherein the first reflectivity R1 is selected from the range of at least 50% and wherein the second reflectivity is selected from the range of 5-40%.

11. The light generating device according to claim 9, wherein the gas voids in the first elongated part have a number average particle size of at maximum 0.5 mm and at minimum 0.02 mm, and wherein the gas voids in the second elongated part have a number average particle size of at least 0.6 mm and at maximum 1.8 mm.

12. The light generating device according to claim 9, wherein the first circular sector has a first central angle selected from the range of 45-315°, wherein the second circular sector has second central angle selected from the range of 45-315°, and wherein 240°≤θ1+θ2≤360°.

13. The light generating device according to claim 1, wherein the polymeric foam material is selected from the group comprising PP, SAN, PMMA, PMMI, PC, PU, PET, PEN, or a copolyester of one or more of the afore-mentioned.

14. The light generating device according to claim 1, further comprising an electronic component, wherein the electronic component is enclosed by the enclosure.

15. A luminaire comprising the light generating device according to claim 1.
